(19) United States
(12) Patent Application Publication
(10) Pub. No.: US 2017/0177829 A1
(43) Pub. Date: Jun. 22, 2017

(54) SYSTEM AND METHOD FOR MANAGING CONFLICTING RULES WITHIN A RULES BASED SOFTWARE ENGINE

(71) Applicant: BenMedica, LLC, St. Louis, MO (US)

(72) Inventors: Bruce Wilkinson, St. Louis, MO (US); Greg Brandt, West St. Paul, MN (US)

(21) Appl. No.: 14/976,060

(22) Filed: Dec. 21, 2015

(51) Int. Cl. G06F 19/00

(52) U.S. Cl. CPC G06F 19/3456; G06F 19/322; G06F 19/326; G06F 19/328

(57) ABSTRACT

A system for managing conflicting rules within a rules based software engine related to pharmacy benefits is disclosed which has a server system for receiving information relating to a drug that may be prescribed to a patient, the drug having more than one prescribed formulations with one of the formulations being preferred over the other formulations, the server system for determining whether there is a conflict between the preferred formulation and the other formulations to provide an indication that the conflict exists and that the conflict should be resolved before the preferred drug may be displayed within an electronic health record, the server system for receiving information relating to the resolution of the conflict and for indicating that the conflict has been resolved, and the server system for allowing the preferred drug to be prescribed to the patient once the conflict has been resolved.

### BACKGROUND

This disclosure relates to a system and method for managing prescription and medical benefits and more particularly to a system and method for managing conflicting rules within a rules based software engine related to pharmacy benefits.

Healthcare costs have increased over the past few decades and cost reduction or containment has been a problem. Healthcare costs related to prescription medications are not only expensive, but are complex and confusing for Pharmacy Benefit Managers (PBMs), insurance companies, healthcare providers, and patients. In an effort to solve this problem PBMs were established to process claims for prescription drug benefits. The PBMs are separate from health insurance companies and process prescription drug benefits claims for the health insurance companies. In a typical transaction, a doctor prescribes a drug for a patient and the patient has the prescription filled at a pharmacy. If the patient has a prescription drug benefit as part of the patient's health insurance policy then the pharmacy will access the PBM's system to determine the price to be charged for the prescribed drug.

In a further effort to reduce or contain drug costs electronic prescribing or e-prescribing started in the United States in 2002 with the establishment of RxHub by the three largest PBMs (AdvancePCS, Express Scripts and Medco). RxHub was founded to help reduce the cost of prescription drugs. E-prescribing reduces costs in two direct ways: prescription drug dispensing operations and drug selection. Operationally, e-prescribing shifted the transaction process from phone, fax, and mail to an automated electronic channel. On the prescription side, e-prescribing helps inform physicians or prescribers which drugs are lowest cost for the patient at the point of care. Previously, prescribers used paper books or third party websites to look up numerous health plan drug formularies to determine which drugs were preferred according to a specific insurance plan. An additional saving opportunity is making the patient's medication history available to the prescriber which helps avoid drug interactions, reduce hospital admittance, and prevent drug abuse. The following transactions are the base requirements for e-prescribing: (a) Eligibility—Confirm the payer who covered the patient that was in the prescriber's office. When eligibility was returned, the e-prescribing vendor would have additional information to display such as Formulary and Benefit and enable prescribers to request medication history; (b) Formulary and Benefit (F & B)—Informs prescribers in real time during a patient visit or encounter which medications are covered by a patient's drug benefit and provides additional information about co-pay and cover limitations; (c) Medication History—Provides the prescription claims history of patients so that a prescriber has a more complete view of the prescriptions that a patient is taking, including prescriptions written by other prescribers; and (d) Prescription Routing—Allows prescribers to transmit prescriptions electronically to a local pharmacy or a mail order pharmacy instead of printing or faxing the prescriptions.

Shortly after RxHub was founded, retail pharmacies created SureScripts to compete against RxHub. The founding pharmacies of SureScripts were CVS, NACDS (National Association of Chain Drug Stores), and Walgreens. SureScripts focused on electronically routing scripts to retail pharmacies. Around 2009, RxHub and SureScripts merged, creating Surescripts. They were merged to reduce duplication of services, combine the complementary focus of both entities, and support additional transactions such as RxCancel, RxChange, RxFill Status, Point to Point (CUSTOM), electronic prior authorization (ePA) and clinical messaging.

An overview of the e-prescribing ecosystem identifies the shareholders and actions that are necessary to complete an e-prescribing transaction. The connected network enables all stakeholders to participate in reducing healthcare costs while better serving the patient. The PBMs and insurance health plans have the patient specific coverage information that prescribers need to clinically treat their patients for the lowest cost at the point of care.

To understand e-prescribing and how it functions, a transaction flow should be presented. The first step is to provide the recipients the necessary data ahead of time. Once the necessary data is loaded correctly across the network, e-prescribing can now function in a real-time manner. Either the prescriber will trigger an eligibility request or an EMR (Electronic Medical Record) will send batch eligibility requests overnight based on the prescriber's patient schedule for the next day. Confirming eligibility is the key for most e-prescribing related transactions for it allows stakeholders to identify the patient. Subsequent healthcare transactions include the payer's unique identification to ensure that all transactions are patient specific. The eligibility transaction (request/response) takes between one and three seconds from end to end so it is considered real-time. Once the patient has been identified, it enables the EMR to display the F&B information based on the patient and for stakeholders to exchange patient related transactions through Surescripts such as medication history.

Medication history is an example of an existing transaction that leverages the electronic channel to provide healthcare professionals with additional information to treat their patients better and preferably at the time of the patient visit. By providing F&B and medication history, the prescriber is able to make more informed decisions regarding the patient's health plan coverage. It lowers the costs of healthcare to all stakeholders. The prescriber can select lower costs drugs through F&B, improve medication therapy adherence since less expensive medications are more likely to be taken regularly by patients, and reduce calls to the prescriber regarding expensive co-pay or prior authorization requirements. The prescriber is also capable of viewing patient medication history to make more informed choices to prevent drug to drug interactions and to prevent duplication of medications. Other unnecessary operational costs, such as phone, fax, and mail costs, are greatly reduced or eliminated by prescribing the optimal drug in a clean legible prescription thus avoiding potential prescription rework.

The current e-prescribing process has most stakeholders sharing information using standard processes and transactions. However, additional optimization can be implemented by providing tools to payers improving the quality of information at the point of care. By using the existing e-prescribing infrastructure, it is possible to provide new services for prescribers. In particular, by providing accurate and succinct information at the point of care, prescribers can rely on payer connected applications for data to assist the prescribers in determining coverage options for patient management.

Although e-prescribing is beneficial, there are still problems that have not been addressed or resolved. In particular, when a prescription is being filled there are various decisions that need to be made to fill the prescription. For example, the health insurance policy may cover a generic drug at one price or co-pay and a brand name version of the same drug at different price or co-pay. It is also possible that various tiers for the drug may exist or competing versions of a drug may be available. If this occurs then the prescriber and the patient are presented with various decisions to be made concerning a prescription. To complicate matters further, various contracted prices for a drug may be charged for different dosages of the same drug or different versions of the same drug. It is also possible that during the term of a healthcare insurance policy or contract that one or more drugs may change from being a covered drug under the insurance policy to a drug that the insurance policy will not cover. In view of this, it is important to be knowledgeable and up to date concerning the specific drug benefits of the insurance policy.

Another problem associated with e-prescribing that needs to be addressed concerns being able to resolve any conflict in which a drug should be filled by a prescription. In particular, some drug benefits policies rely on rules to manage processing of prescription drugs. For example, a simple rule may be that Drug X should be treated as a non-formulary drug on the patient's formulary. A PBM may have rules that dictate that the primary rule is that all generic drugs have a preferred formulary status and a secondary rule that any generic drugs should not be displayed as preferred, that do not conform to the original rule, would have additional rules as exceptions to the primary rule. As can be appreciated, these rules may become stacked and the system user needs to be aware that the same drug may have more than one rule that applies to the drug. However, there is no way to quickly review and analyze which rules take precedence and which rule for a specific drug is dominant. Some systems are required to manage over 20,000 prescription drugs, over the counter drugs, and medical supplies. As can be appreciated, as the number of prescription drugs, over the counter drugs, and medical supplies increases, the complexity of the system increases making management of the system more difficult.

Therefore, it would be desirable to have a system and method for managing conflicting rules within a rules based software engine related to pharmacy benefits. It would be advantageous to have a system and method that allows a user to quickly and easily review and analyze rules concerning drug benefits to determine if there is any conflict within the rules. Once a conflict is identified, it would also be advantageous to have a system and method that allows a user to either override or resolve the conflict or accept the precedence.

### SUMMARY

In one form of the present disclosure, a system for managing conflicting rules within a rules based software engine related to pharmacy benefits is disclosed which comprises a server system for receiving information relating to a drug that may be prescribed to a patient, the drug having more than one prescribed formulations with one of the formulations being preferred over the other formulations, the server system for determining whether there is a conflict between the preferred formulation and the other formulations to provide an indication that the conflict exists and that the conflict should be resolved before the preferred drug may be displayed within an EMR, the server system for receiving information relating to the resolution of the conflict and for indicating that the conflict has been resolved, and the server system for allowing the preferred drug to be prescribed to the patient once the conflict has been resolved.

In another form of the present disclosure, system for managing conflicting rules within a rules based software engine related to pharmacy benefits is disclosed which comprises a server system for receiving information relating to a drug that may be prescribed to a patient, the drug having multiple prescribable formulations with one of the formulations being preferred over the other formulations, the server system for determining whether there is a conflict between the preferred formulation and the other formations to provide an indication that the conflict exists and that the conflict should be resolved before the preferred drug may be displayed within an electronic health record, the server system for receiving information relating to the resolution of the conflict and for indicating that the conflict has been resolved, and the server system for allowing the preferred drug to be displayed within the electronic health record once the conflict has been resolved and a customer device for connection to the server system over a connection, the customer device having a display for displaying screens that are received from the server system over the connection, and an input device for controlling operation of the display to select a portion of the screen.

In yet another form of the present disclosure, a method for managing conflicting rules within a rules based software engine related to pharmacy benefits is disclosed which comprises the steps of providing a server system for receiving information relating to a drug that may be prescribed to a patient, the drug having more than one prescribed formulations with one of the formulations being preferred over the other formulations, the server system for determining whether there is a conflict between the preferred formulation and the other formulations to provide an indication that the conflict exists and that the conflict should be resolved before the preferred drug may be displayed within an electronic health record, the server system for receiving information relating to the resolution of the conflict and for indicating that the conflict has been resolved, and the server system for allowing the preferred drug to be prescribed to the patient once the conflict has been resolved and providing a customer device for connection to the server system over a connection, the customer device having a display for displaying screens that are received from the server system over the connection, and an input device for controlling operation of the display to select a portion of the screen.

In light of the foregoing comments, it will be recognized that the present disclosure provides a system and method for managing conflicting rules within a rules based software engine related to pharmacy benefits.

The present disclosure provides a system and method for managing conflicting rules within a rules based software engine related to pharmacy benefits in which information or data concerning pharmacy benefits can be controlled or managed by a user.

The present disclosure provides a system and method for managing conflicting rules within a rules based software engine related to pharmacy benefits in which various levels of information or data are visible to users.

The present disclosure provides a system and method for managing conflicting rules within a rules based software engine related to pharmacy benefits in which various levels of information or data can be overridden to allow specific users access to the information or data to control the information or data.

The present disclosure provides a system and method for managing conflicting rules within a rules based software engine related to pharmacy benefits which provides a user the ability to review pharmacy benefits and to override conflicting pharmacy benefits.

The present disclosure is directed to a system and method for managing conflicting rules within a rules based software engine related to pharmacy benefits which serves as a centralized repository or hub for management and monitoring of pharmacy benefits.

The present disclosure provides a system and method for managing conflicting rules within a rules based software engine related to pharmacy benefits which is a flexible system in that different pharmacy benefits may be reviewed and considered to provide a determination as to which pharmacy benefit should prevail.

These and other advantages of the present system and method for managing conflicting rules within a rules based software engine related to pharmacy benefits will become apparent after considering the following detailed specification in conjunction with the accompanying drawings, wherein:

### BRIEF DESCRIPTION OF THE DRAWINGS

FIG. 1 is a block diagram of a system for managing conflicting rules within a rules based software engine constructed according to the present disclosure;

FIG. 2 is a flow chart diagram of a program for operating the system and method for managing conflicting rules within a rules based software engine constructed according to the present disclosure;

FIG. 3 is a flow chart diagram of another program for operating the system and method for managing conflicting rules within a rules based software engine constructed according to the present disclosure;

FIG. 4 is an illustration of a screen which may be presented during use of the system for managing conflicting rules within a rules based software engine constructed according to the present disclosure;

FIG. 5 is an illustration of a screen which may be presented during use of the system for managing conflicting rules within a rules based software engine constructed according to the present disclosure; and

FIG. 6 is an illustration of a screen which may be presented during use of the system for managing conflicting rules within a rules based software engine constructed according to the present disclosure.

### DETAILED DESCRIPTION

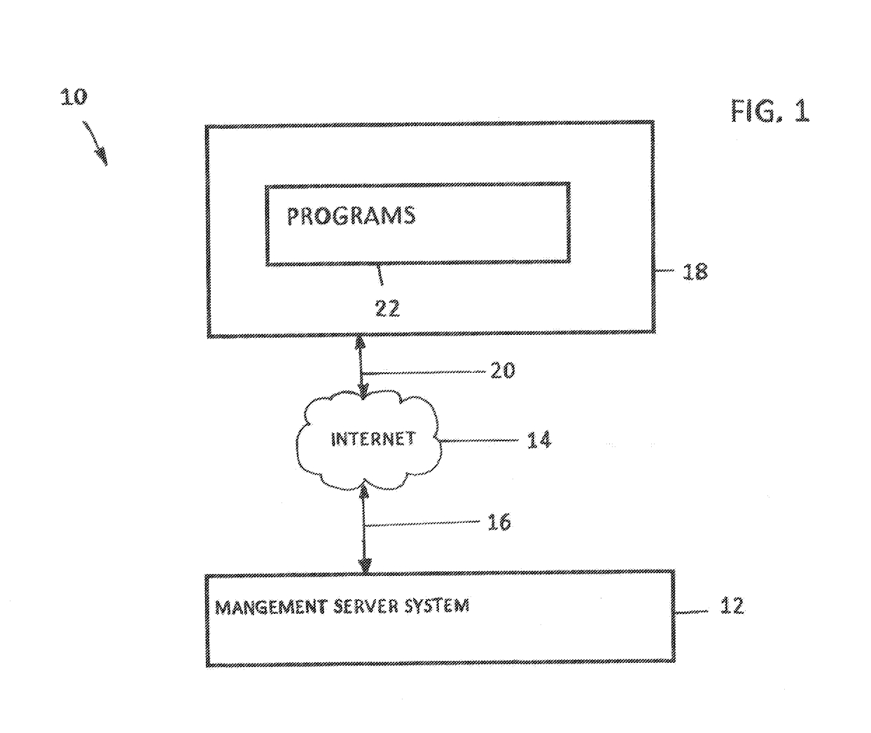

Referring now to the drawings, wherein like numbers refer to like items, number 10 identifies a system for managing conflicting rules within a rules based software engine related to pharmacy benefits constructed according to the present disclosure. With reference now to FIG. 1, the system 10 is shown to comprise a management server system 12 that is connected to a communications network such as a network switch or the Internet 14 via a connection 16. The server system 12 may comprise a computer network that is capable of storing software programs and data. The server system 12 may comprise a single computer system or a number of computer systems grouped together. The server system 12 may include a database or other similar system for storing information relating to pharmacy benefits, patient information, and insurance policy information to be retrieved and used by individuals or entities that enroll in, use, or have access to the system 10 such as an electronic medical records (EMR) system. Further, by way of example only, the computer 12 may be a computer having a microprocessor, memory, a hard drive having stored thereon an operating system and other software, input devices such as a mouse or a keyboard, a CD-ROM drive, and USB ports. Other ancillary devices may be included such as a printer, a scanner, a modem, a router, or other network devices that allow the server system 12 to be connected to the Internet 14 or other network. The connection 16 may take on various forms such as a telephone line, cable, ISDN lines, fiber optic lines, wireless connections, microwave, radio, satellites, or other connection devices or means.

A customer device 18, such as a computer, a tablet, a smart phone, or any other device which is capable of communicating with the server system 12, is also connected to the Internet 14 by a connection 20. The connection 20 may take on the same form or forms as the connection 16, but may also be a wireless connection or a WiFi connection. The customer device 18 has the capability of having various programs 22, such as software programs or software applications, resident or stored in the device 18. One of the programs may be a web browser that allows for sending and receiving information to and from the server system 12.

By way of further example only, the customer device 18 may be other devices such as a smart phone, a personal digital assistant (PDA), an iPad or other tablet, a device that has WiFi connectivity, or other mobile communications device capable of sending and receiving data over a wireless or wired network. Although not shown in any detail, the customer device 18 may have a microprocessor, memory, a hard drive having stored thereon an operating system and other software, input devices such as a mouse or a keyboard, a CD-ROM drive, and USB ports. Other ancillary devices may be included or attached to the customer device 18 such as a printer, a scanner, a modem, a router, or other network devices that allow the device 18 to be connected to the Internet 14 or other network. Further, although one customer device 18 is illustrated and discussed, it is possible and anticipated that more than one customer device 18 may be connected to the server system 12 over the Internet 14. It is also possible that a user of the system 10 can use different devices 18 to access the server system 12. For example, the user may not be near a computer and the user will have to use a smart phone to access the server system 12.

The server system 12 has a software platform or program therein that is designed to allow users associated with the server system 12, such as a user of the customer device 18, to access the server system 12 to manage conflicting rules within a rules based software engine related to pharmacy benefits. The server system 12 may have a website associated with it that has a web page or home page that acts as a portal to connect various individuals, users, or members of the server system 12. Once each user is connected to the server system 12, information may be displayed as a user interface to the member. The user interface may contain relevant information that is displayed as a web page on a screen of the device 18. The information that may be displayed is based on the patient's insurance policy, information about the patient, information about the patient's medication history, and information about the patient's pharmacy benefits.

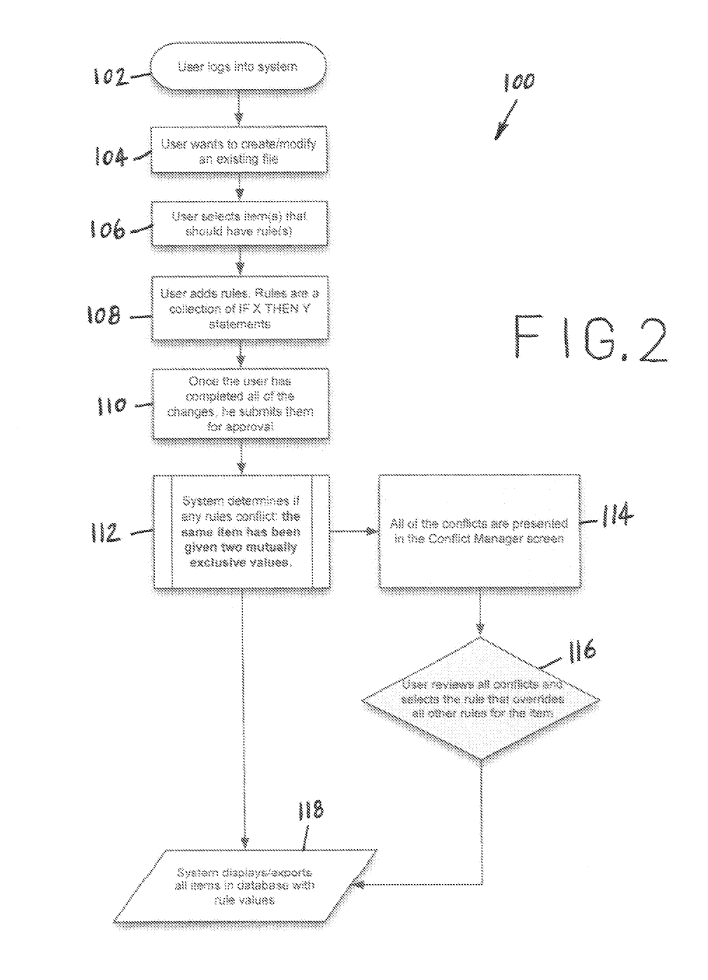

FIG. 2 is a flow chart diagram of a process, method, or program 100 for operating the system 10. In an initial step 102, a user or customer will log into system 10. Once logged in, a next step 104 is encountered in which the user will create a file or modify an existing file. The user will select items that should have rules, in a next step 106. Once the user makes the noted selection in the step 106, a next step 108 is encountered where the user adds rules. For example, rules are a collection of IF X THEN Y statements. Once the rules are added, in a next step 110, all of the changes are submitted for approval by the system 10. The system 10 will determine if any of the submitted rules have a conflict with a previous rule in a step 112. In particular, it will be determined if the same item, a particular drug or drug dosage and form, has been give two mutually exclusive values. If the system 10 determines that there is a conflict then control of the program passes to a step 114. In the step 114, all of the conflicts are presented to the user in a conflict manager screen on a display associated with the customer device 18 (FIG. 1). After the screen is displayed, the user reviews all of the conflicts and selects the rule that overrides all of the other rules for that particular item. This is accomplished in a step 116. Once the conflict has been resolved in the step 116, control of the program 100 passes to a step 118. In the step 118, the system 10 displays and/or exports all items in the database with rule values. Also, if in the step 112 there was no conflict determined, then control of the program 100 will pass directly to the step 118.

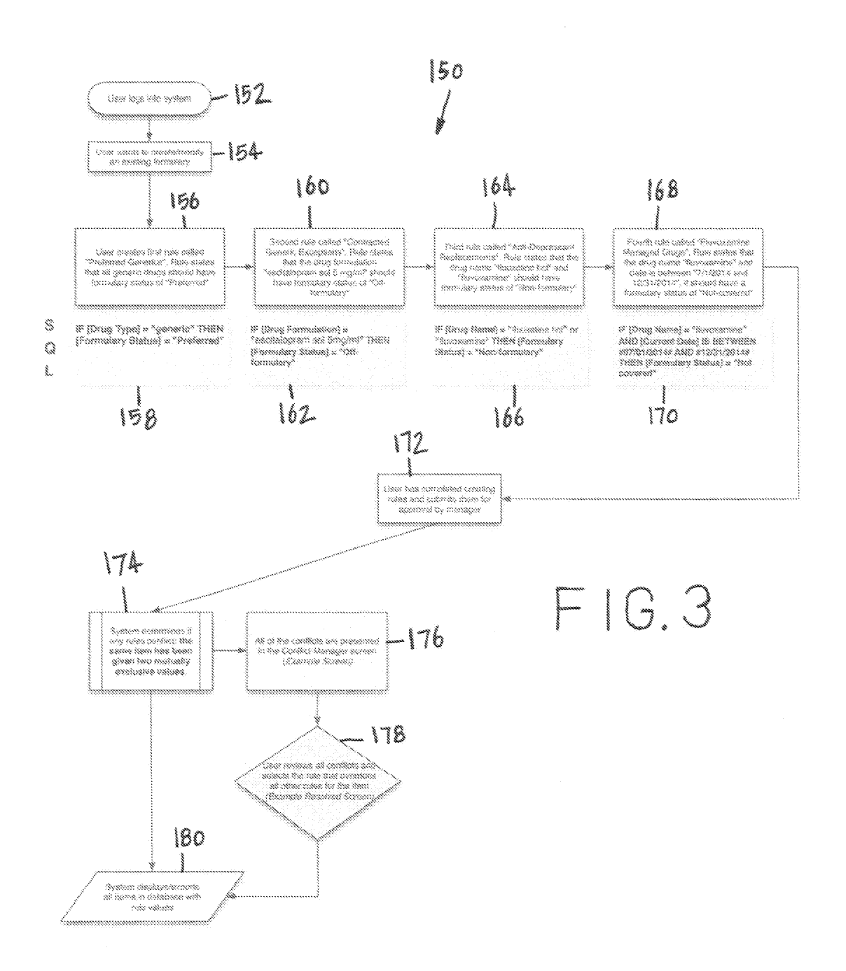

With reference now to FIG. 3, another flow chart diagram of a program 150 for operating the system 10 is shown. The program 150 begins at a step 152 in which a user logs into the system 10. Once logged into the system 10, the user encounters a next step 154 in which the user will create or modify a formulary or other pharmacy benefit information for one or more drugs. In a next step 156, the user creates or modifies a first rule, which is referred to as a preferred generics. The rule states that all generic drugs should have a formulary status of being preferred. In particular, a SQL (structured query language) command, which is shown in a box 158, may be IF [Drug Type]=“generic” THEN [Formulary Status]=“Preferred”. In a next step 160, the user may enter a second rule, which is called a contracted generic exception. For example, this rule states that the drug formulation “escitalopram sol 5 mg/ml should have a formulary status of being off-formulary. The SQL command for this rule may be IF [Drug Formulation]=“escitalopram sol 5 mg/ml” THEN [Formulary Status]=“Off-formulary”. This SQL command is shown in a box 162. In a next step 164, a third rule may be entered by the user. The third rule is called “Anti-Depressant Replacements”. The third rule states that the drug name “fluoxetine hcl” and “fluvoxamine” should have formulary status of “Non-formulary”. The SQL command for this third rule, shown in a box 166, is IF [Drug Name]=“fluoxetine hcl” or “fluvoxamine” THEN [Formulary Status]=“Non-formulary”. A fourth rule may be entered in a next step 168. The fourth rule concerns fluvoxamine managed drugs. The fourth rule states that the drug name “fluvoxamine” and a date between, for example only, Jul. 1, 2014, and Dec. 31, 2014, should have a formulary status of “Not covered”. An example of a SQL command for this fourth rule is shown in a box 170. The SQL command may be IF [Drug Name]=“fluvoxamine” AND [Current Date] IS BETWEEN #07/01/2014# AND #12/31/2014# THEN [Formulary Status]=“Not covered”. Once the fourth rule has been entered or modified, control of the program 150 passes to a step 172. In the step 172, the user has completed creating or modifying rules and the rules are submitted for approval. The system 10 determines if any of the rules conflict in a step 174. If it is determined that the same item has been given two mutually exclusive values then the program 150 will pass control to a next step 176 in which all of the conflicts will be presented in a conflicts manager screen. Once the conflicts are displayed, the user will review the conflicts and select the rule that overrides all other rules for the item in a step 178. After the conflicts are resolved, the program 150 continues to a step 180 in which the system 10 displays and/or exports all items in the database with rule values. Also, if in the step 174 there was no conflict determined, then control of the program 150 will pass directly to the step 180.

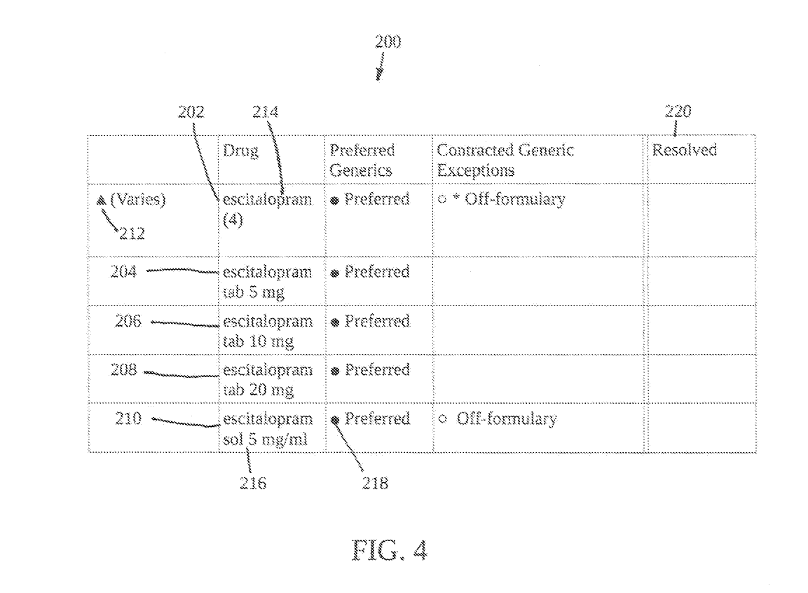

FIG. 4 illustrates a screen or web page 200 that may be displayed on the customer device 18 that has accessed the website associated with the server system 12. The screen 200 shows an example of a drug 202, such as escitalopram, that has been added to the list of drugs that are available for prescription under a drug benefits insurance policy. The drug 202 has a first formulation 204, escitalopram tab 5 mg, a second formulation 206, escitalopram 10 mg, a third formulation 208, escitalopram 20 mg, and a fourth formulation 210, escitalopram sol 5 mg/ml. All of the formulations 202, 204, 206, 208, and 210 have been initially indicated as being a preferred generic drug to be prescribed. However, the system 10 has identified there being a conflict by a conflict indicator 212 being displayed. Also, to further indicate that a conflict has been determined, the drug 202 or a row 214 associated with the drug 202 may be highlighted in the web page 200. For example, the background color of the row 214 may be a different color than other colors depicted in the web page 200. Further, the conflict within the drug 202 may also be highlighted with a color, which may or may not be the same color as within the row 214. In this particular view, a row 216, which is associated with the fourth formulation 210, may be highlighted to indicate that the fourth formulation 210 is in conflict and must be resolved. In this event, the user must resolve the conflict by selecting which rule will override the conflict. In this particular situation, it was determined that the fourth formulation 210 should be moved to an off-formulary condition to resolve the conflict. This is accomplished by deselecting a round box 218 associated with for the fourth formulation 210. Once the box 218 is deselected and no other conflicts are present, the user may select a Resolved box 220.

The screen 200 may display all drugs in the system 10 or only drugs that have determined conflicts. Drugs may be filtered by additional qualifiers such as therapeutic class or brand/generic, or a number of other potential qualifiers. Drugs are displayed by their product name. A menu or symbol may be selected to further expand the product name to show the formulations associated with the drug. The drug 202 may also have a numeral next to it to indicate the number of unique formulations associated with the drug 202, a symbol to indicate if there is a conflict, and if the conflict exist across all formulations or a subset of formulations. If there is a conflict, then the user is shown the status based on the rule. The user may select a rule at the drug name, creating an override at the top level for all formulations or may expand the drug to see all formulations and select individually which rule takes precedence for each formulation. Default is the highest precedent rule. If there is a time based conflict, then the date appears beneath the drug name level. If the drug is expanded, each formulation with the date conflict has the dates displayed below it. Each drug grouping has its own column names for relevant rules.

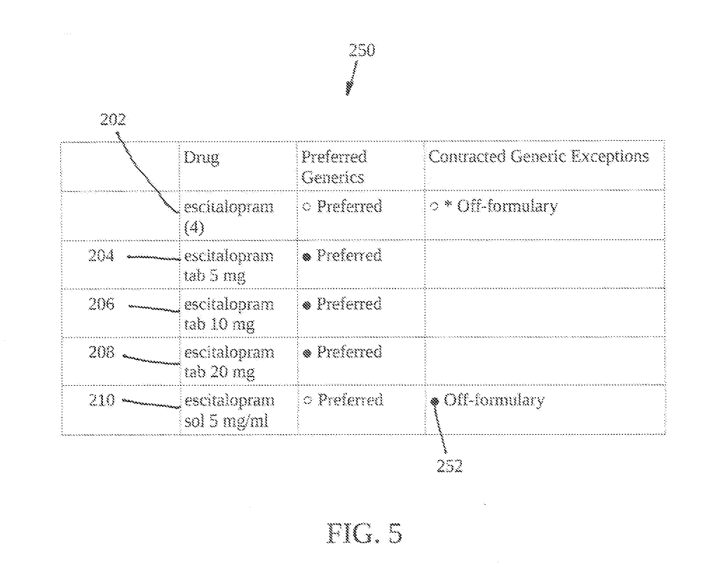

Referring now to FIG. 5, a screen or web page 250 is illustrated which is an example of a screen or web page that would be displayed after the conflict shown in the screen 200 is resolved. The screen 250 shows that the drug (escitalopram) 202 has the first formulation 204, the second formulation 206, the third formulation 208, and the fourth formulation 210 being listed in the screen 250. It should be noticed that there is now no conflict indicator 212 being displayed. This means that all of the conflicts have been resolved. A rounded box 252 associated with the fourth formulation 210 has been highlighted or filled in to note that the fourth formulation 210 is off-formulary. This may indicate to a physician to either prescribe a different formulation to be filled by a pharmacy or to alert a patient that the fourth formulation 210 may be more expensive than a generic drug or formulation under the insurance policy for the patient. The row 216 that is associated with the fourth formulation 210 may be highlighted by a color to indicate that there was a previous conflict with the fourth formulation 210 or that a change has been made to the fourth formulation 201.

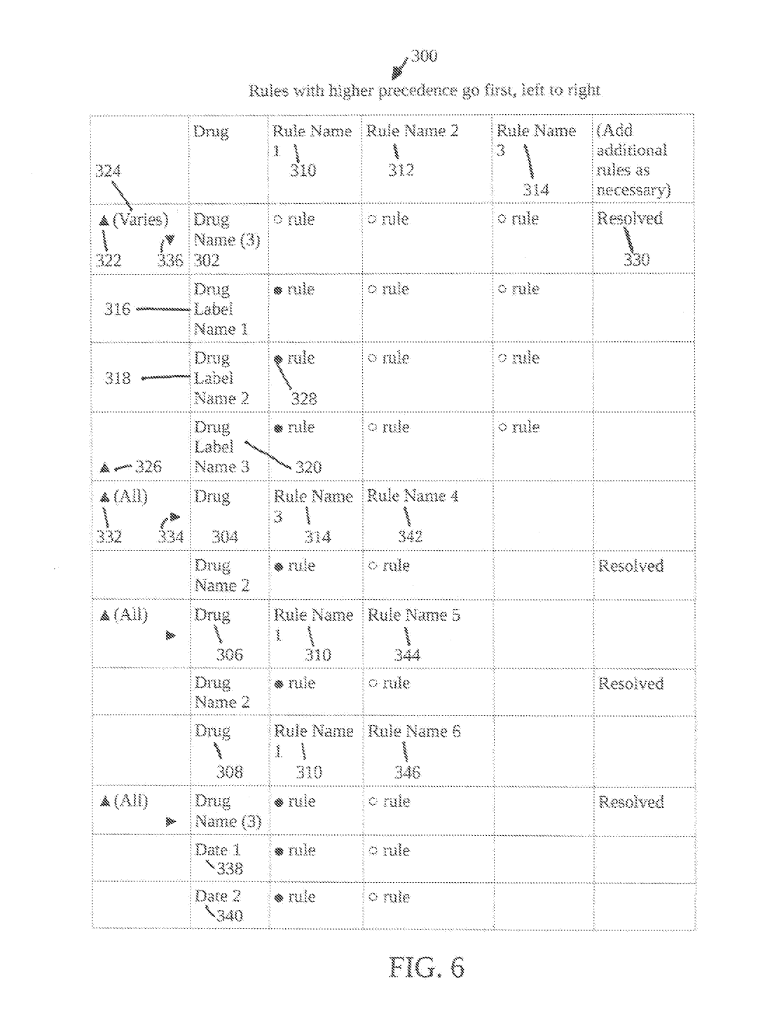

FIG. 6 shows a screen or web page 300 that may be displayed on the customer device 18 that has accessed the website associated with the server system 12. The screen 300 shows an example of a first drug 302, a second drug 304, a third drug 306, and a fourth drug 308 that may be displayed or presented to a user of the system 10. The first drug 302 has a first rule name 310, a second rule name 312, and a third rule name 314 associated with the first drug 302 that may be used to resolve a conflict that has been determined by the system 10. The first drug 302 has a first drug label name 316, a second drug label name 318, and a third drug label name 320 associated with the first drug 302. The first drug 302 has a first conflict indicator 322 for indicating that conflict has been determined with the first drug 302. A first secondary conflict indicator 324 is shown that is used to alert the user of the system 10 that the conflict may vary between the first drug label name 316, the second drug label name 318, and the third drug label name 320. The third drug label name 320 also has a second conflict indicator 326 that is used to further identify a particular conflict with the third drug label name 320 that needs to be addressed or reviewed to be resolved. As has been previously described, each rule and each drug has a radio button 328 associated therewith that may be selected or deselected in order to resolve a conflict. Also, each drug 302, 304, 306, and 308 has a Resolved box 330 that may be selected to indicate that a conflict has been reviewed and has been resolved by the user of the system 10.

The second drug 304 has a first conflict indicator 332 associated with the second drug 304. The first conflict indicator 332 signifies that the user of the system 10 has a conflict that needs to be resolved with respect to the second drug 304. The second drug 304 also has an expanding indicator 334 that means that the second drug 304 can be expanded to show all of the drug label names associated with the second drug 304. The first drug 302 also has an expanding indicator 336 in which the indicator 336 has been selected to expand the list of drug label names 316, 318, and 320 under the first drug 302. When the expanding indicator 336 is selected, it should be noted that the indicator 336 changes orientation to indicate that the indicator 336 can be contracted. For example, the indicator 334 is shown being orientated in a contracted state. In order to expand the second drug 304, the indicator 334 may be selected by the user of the system 10. The fourth drug 308 shows that a drug may be limited by a date rule. For example, the fourth drug 308 may be prescribed during a first date period 338 or a second date period 340.

The second drug 304 is shown as being controlled by the third rule name 314 and a fourth rule name 342. Any conflict to be resolved with respect to the second drug 304 will be resolved between the third rule name 314 and the fourth rule name 342. The third drug 306 is under the control of the first rule name 310 and a fifth rule name 344. The fourth drug 308 is controlled by the first rule name 310 and a sixth rule name 346. This shows that each of the drugs 302, 304, 306, and 308 may be controlled by different rule names, such as the rule names 310, 312, 314, 342, 344, and 346. This also shows that there may be various rules that control which drug may be prescribed under the health insurance policy for the insured patient.

As has been described, the system 10 may be a service provided at a website associated with the server system 12. The user interfaces by use of the screens 200, 250 and 300, to facilitate and allow users of the system 10 to easily resolve conflicts to allow a patient to obtain a prescription drug at the lowest cost. The system 10 assists payers, such as PBMs and health plans, leverage technology to improve healthcare. The system 10 allows payers to take advantage of real time connectivity between electronic medical record systems used by prescribers and patients to obtain a prescription drug at the lowest cost under the various agreements between the payer, the healthcare provider, and the patient. By providing prescribers with more accurate information at the point of care, health outcomes may be improved through safer and lower cost medications.

Computer program code for carrying out operations of the system 10 may be written in any suitable programming language or combination of programming languages, such as an object oriented programming language. Some examples of suitable programming languages are Java, C++, the “C” programming language, or similar other programming languages. The program code may execute entirely on the customer's device 18, partly on the customer's device 18, as a stand-alone software package, partly on the customer's device 18 and partly on the server system 12 or entirely on the server system 12. As has previously been described, the server system 12 may be connected to the customer's device 18 through any type of network, including a local area network (LAN) or a wide area network (WAN), or the connection may be made to an external computer (for example, through the Internet using an Internet Service Provider.

The order of execution or performance of the operations in embodiments of the system and method illustrated and described herein is not essential, unless otherwise specified. That is, the operations may be performed in any order, unless otherwise specified, and embodiments of the system and method may include additional or fewer operations than those disclosed herein. For example, it is contemplated that executing or performing a particular operation before, contemporaneously with, or after another operation is within the scope of aspects of the present disclosure. Further, it is also possible that two operations may be executed substantially concurrently or in reverse order, depending upon the functionality involved.

From all that has been said, it will be clear that there has thus been shown and described herein a system and method for managing conflicting rules within a rules based software engine related to pharmacy benefits which fulfills the various advantages sought therefore. It will become apparent to those skilled in the art, however, that many changes, modifications, variations, and other uses and applications of the subject a system and method for managing conflicting rules within a rules based software engine related to pharmacy benefits are possible and contemplated. All changes, modifications, variations, and other uses and applications which do not depart from the spirit and scope of the disclosure are deemed to be covered by the disclosure, which is limited only by the claims which follow.

What is claimed is:

1. A system for managing conflicting rules within a rules based software engine related to pharmacy benefits comprising:
a server system for receiving information relating to a drug that may be prescribed to a patient, the drug having more than one prescribed formulations with one of the formulations being preferred over the other formulations, the server system for determining whether there is a conflict between the preferred formulation and the other formulations to provide an indication that the conflict exists and that the conflict should be resolved before the preferred drug may be displayed within an electronic medical record, the server system for receiving information relating to the resolution of the conflict and for indicating that the conflict has been resolved, and the server system for allowing the preferred drug to be prescribed to the patient once the conflict has been resolved.

2. The system for managing conflicting rules within a rules based software engine related to pharmacy benefits of claim 1 wherein the preferred formulation is determined based upon a rule.

3. The system for managing conflicting rules within a rules based software engine related to pharmacy benefits of claim 1 wherein the preferred formation is determined based upon a number of rules.

4. The system for managing conflicting rules within a rules based software engine related to pharmacy benefits of claim 1 wherein the preferred formulation may be time based.

5. The system for managing conflicting rules within a rules based software engine related to pharmacy benefits of claim 1 wherein there may be a number of preferred formulations to be prescribed to the patient.

6. The system for managing conflicting rules within a rules based software engine related to pharmacy benefits of claim 1 wherein the preferred formulation may be changed to a non-preferred formulation.

7. The system for managing conflicting rules within a rules based software engine related to pharmacy benefits of claim 1 wherein the server system is capable of receiving information over a connection.

8. The system for managing conflicting rules within a rules based software engine related to pharmacy benefits of claim 1 wherein the server system is capable of transmitting information over a connection.

9. A system for managing conflicting rules within a rules based software engine related to pharmacy benefits comprising:
a server system for receiving information relating to a drug that may be prescribed to a patient, the drug having multiple prescribable formulations with one of the formulations being preferred over the other formulations, the server system for determining whether there is a conflict between the preferred formulation and the other formations to provide an indication that the conflict exists and that the conflict should be resolved before the preferred drug may be displayed within an electronic health record, the server system for receiving information relating to the resolution of the conflict and for indicating that the conflict has been resolved, and the server system for allowing the preferred drug to be displayed within the electronic health record once the conflict has been resolved; and
a customer device for connection to the server system over a connection, the customer device having a display for displaying screens that are received from the server system over the connection, and an input device for controlling operation of the display to select a portion of the screen.

10. The system for managing conflicting rules within a rules based software engine related to pharmacy benefits of claim 9 wherein the preferred formulation is determined based upon a rule.

11. The system for managing conflicting rules within a rules based software engine related to pharmacy benefits of claim 9 wherein one of the screens received from the server system and displayed on the display of the customer device comprises a conflict indicator.

12. The system for managing conflicting rules within a rules based software engine related to pharmacy benefits of claim 9 wherein one of the screens received from the server system and displayed on the display of the customer device comprises a resolution indicator.

13. The system for managing conflicting rules within a rules based software engine related to pharmacy benefits of claim 9 wherein one of the screens received from the server system and displayed on the display of the customer device comprises a secondary conflict indicator.

14. The system for managing conflicting rules within a rules based software engine related to pharmacy benefits of claim 9 wherein one of the screens received from the server system and displayed on the display of the customer device comprises a conflict indicator associated with the preferred drug formulation and each of the other drug formulations.

15. The system for managing conflicting rules within a rules based software engine related to pharmacy benefits of claim 9 wherein one of the screens received from the server system and displayed on the display of the customer device comprises a button to select a rule.

16. A method for managing conflicting rules within a rules based software engine related to pharmacy benefits comprising the steps of:
providing a server system for receiving information relating to a drug that may be prescribed to a patient, the drug having more than one prescribed formulations with one of the formulations being preferred over the other formulations, the server system for determining whether there is a conflict between the preferred formulation and the other formulations to provide an indication that the conflict exists and that the conflict should be resolved before the preferred drug may be displayed within an electronic health record, the server system for receiving information relating to the resolution of the conflict and for indicating that the conflict has been resolved, and the server system for allowing the preferred drug to be prescribed to the patient once the conflict has been resolved; and
providing a customer device for connection to the server system over a connection, the customer device having a display for displaying screens that are received from the server system over the connection, and an input device for controlling operation of the display to select a portion of the screen.

17. The method for managing conflicting rules within a rules based software engine related to pharmacy benefits of claim 16 further comprising the step of determining the preferred formulation based upon a rule.

18. The method for managing conflicting rules within a rules based software engine related to pharmacy benefits of claim 16 further comprising the step of providing a conflict indicator on one of the screens received from the server system and displaying the conflict indicator on the display of the customer device.

19. The method for managing conflicting rules within a rules based software engine related to pharmacy benefits of claim 16 further comprising the step of providing a resolution indicator on one of the screens received from the server system and displaying the resolution indicator on the display of the customer device.

20. The method for managing conflicting rules within a rules based software engine related to pharmacy benefits of claim 16 further comprising the step of providing a button to select a rule on one of the screens received from the server system and displaying the button on the display of the customer device.
